(19) United States
(12) Patent Application Publication
(10) Pub. No.: US 2026/0303168 A1
(43) Pub. Date: Oct. 1, 2026

(54) DOMAIN ADAPTATION AND GENERALIZATION THROUGH KNOWLEDGE DISTILLATION FOR CHANNEL STATE FEEDBACK

(71) Applicant: Apple Inc., Cupertino, CA (US)

(72) Inventors: Konstantinos SARRIGEORGIDIS, Los Gatos, CA (US); Xiang CHEN, Palo Alto, CA (US); Yang TANG, San Jose, CA (US)

(21) Appl. No.: 19/443,781

(22) Filed: Jan. 8, 2026

Related U.S. Application Data
(60) Provisional application No. 63/779,135, filed on Mar. 27, 2025.

(51) Int. Cl. H04B 7/06; H04L 41/16

(52) U.S. Cl. CPC H04B 7/0626; H04L 41/16

(57) ABSTRACT

Methods and apparatuses for domain adaptation and generalization of channel state feedback for a wireless device by using online generation of reduced-complexity models. One such online approach is knowledge distillation. One or more components of a wireless device obtains a set of reference signals received from one or more network devices. One or more components of the wireless device determines a target channel state based on the set of reference signals. One or more components of the wireless device generates, based on the target channel state, a reduced-complexity model from a pre-trained complex model. After generation, the reduced-complexity model is deployed.

### CROSS-REFERENCE TO RELATED APPLICATIONS

The present application claims the benefit of U.S. Provisional Application No. 63/779,135, entitled “DOMAIN ADAPTATION AND GENERALIZATION THROUGH KNOWLEDGE DISTILLATION FOR CHANNEL STATE FEEDBACK,” filed Mar. 27, 2025, the content of which is incorporated by reference herein in its entirety for all purposes.

### FIELD

The described implementations set forth techniques for domain adaptation and generalization of channel state feedback for a wireless device by using online generation of reduced-complexity models.

### BACKGROUND

Wireless devices have been configured to use machine learning models for various management and control tasks, such as channel estimation, transmission beam management, and geographic positioning. Some configuration parameters of such machine learning models can be defined by capabilities of a wireless device (e.g., features, functionality, and configuration). Some configuration parameters of these machine learning models can also be defined by associated identifiers (IDs) that help a wireless device determine functionality applicability (e.g., network side conditions and network-related parameters). Some configuration parameters of these machine learning models cannot be defined based on the capabilities of a wireless device or an associated ID (e.g., parameters related to channel conditions and propagation conditions). There exists a need for mechanisms to generate, at a wireless device, machine learning models configured to account for current conditions that may not be defined by the capabilities of the wireless device or an associated ID.

### SUMMARY

This application sets forth techniques for domain adaptation and generalization of channel state feedback for a wireless device by using online generation of reduced-complexity models, e.g., at the wireless device. One such online approach can be referred to as knowledge distillation. One or more components of a wireless device obtain a set of reference signals received from one or more network devices. For example, a set of channel state reference signals may be obtained. One or more components of the wireless device can determine a target channel state based on the set of obtained reference signals. One or more components of the wireless device can generate, based on the target channel state, a reduced-complexity model from a pre-trained complex model. After generation, the reduced-complexity model can be deployed for use by one or more components of the wireless device.

In some implementations, verification may be performed on the reduced-complexity model to validate performance before full deployment. For example, a key performance indicator (KPI) of the reduced-complexity model may be checked to ensure compliance with a network requirement. In some implementations, the reduced-complexity model includes an encoder for generating compressed representations of channel state (e.g., feedback codewords). In some implementations, the reduced-complexity model includes a decoder for reconstructing a channel state based on feedback codewords. In some implementations, when available locally to one or more components of the wireless device, an inactive reduced-complexity model can be deployed, when performance of the current deployed model degrades, e.g., due to changes in channel conditions. In some implementations, the wireless device can operate in a legacy mode during generation of a reduced-complexity model. For example, the wireless device may operate without using artificial intelligence and machine learning to ensure stable communication during model generation.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some implementations.

FIG. 2 illustrates a block diagram of a more detailed view of an example of components of a wireless device of the system of FIG. 1, according to some implementations.

FIG. 3 illustrates an example of a domain adaptation and generalization flow for online generation of multiple reduced-complexity models, according to some implementations.

FIG. 4 illustrates a diagram of an example of a channel state feedback system, according to some implementations.

FIG. 5 illustrates an example of a student model generation flow to train an encoder for channel state feedback through knowledge distillation, according to some implementations.

FIG. 6 illustrates a diagram of an example of a channel state feedback system, according to some implementations.

FIG. 7 illustrates an example of a student model generation flow to train an encoder and a decoder for channel state feedback through knowledge distillation, according to some implementations.

FIG. 8 is a flow diagram of an example of a method for domain adaptation and generalization for channel state feedback, according to some implementations.

FIG. 9 is a block diagram of an example of a computing device, according to some implementations.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

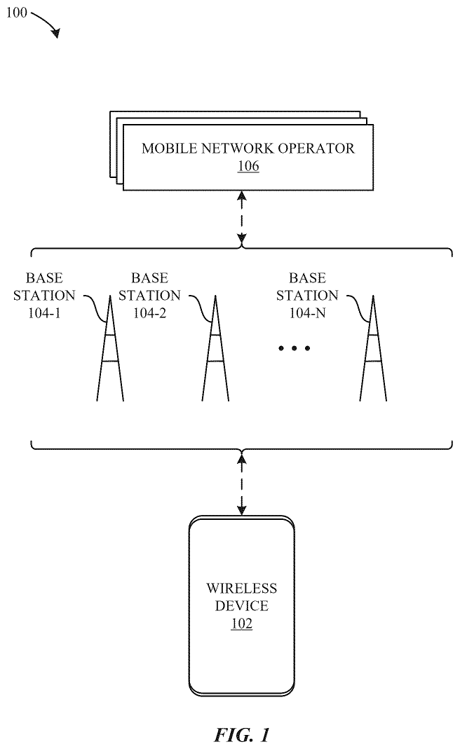

These and other implementations are discussed below with reference to FIGS. 1 through 9; however, those skilled in the art will readily appreciate that the detailed description given herein with respect to these figures is for explanatory purposes only and should not be construed as limiting.

FIG. 1 illustrates a block diagram of different components of a system 100 that includes i) a wireless device 102, which can also be referred to as a mobile wireless device, a cellular wireless device, a wireless communication device, a mobile device, a user equipment (UE), a device, a primary wireless device, a secondary wireless device, an accessory wireless device, a cellular-capable wearable device, and the like, and ii) a group of base stations 104-1 to 104-N, which are managed by one or more mobile network operators (MNOs) 106. The wireless device 102 can represent a mobile computing device (e.g., a phone, a tablet, a peripheral device, etc.). The base stations 104-1 to 104-N can represent cellular radio access network (RAN) entities including fourth generation (4G) Long Term Evolution (LTE) evolved NodeBs (eNodeBs or eNBs), fifth generation (5G) NodeBs (gNodeBs or gNBs), and/or sixth generation (6G) NodeBs that are configured to communicate with the wireless device 102. Each of the base stations 104-1 to 104-n are one example of a “network device.” Each of the base stations 104-1 to 104-n can be a single entity, quasi-collocated entities, or separated among multiple units (e.g., central units (CUs), distributed units (DUs), remote units (RUs)). The MNOs 106 can represent different wireless service providers that provide specific services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections (when available) via one or more of the base stations 104-1 to 104-N.

Beamforming may be used in the system 100 in an effort to optimize wireless communications with the wireless device 102 by focusing signals at the wireless device 102, enhancing efficiency and reliability. Beamforming by a network device may employ multiple antennas and advanced algorithms to create precise, concentrated communication links. This targeted approach boosts signal strength, quality, and data rates, supporting multiple-input multiple-output (MIMO) configurations. By adapting signal direction based on UE location and surroundings, beamforming overcomes obstacles to enable faster speeds and lower latency for users in diverse scenarios and applications. A network device (e.g., a base station or gNB) serving UEs in a coverage area may use a set of beams, each beam of which is associated with a particular set of antenna parameters for transmission and/or reception using one or more sets of antenna arrays at the network device.

In some wireless communication networks, radio resource management (RRM) involves a set of functionalities and procedures to efficiently manage and optimize radio resources in the network. Measurements are used to provide the network with information about the radio environment, allowing the network to make informed decisions for resource allocation, handovers, and other optimization strategies. In the network, both UEs and network devices can transmit reference signals that network devices or UEs can receive and measure. For example, a UE may measure references signals transmitted by a network device to determine reference signal received power (RSRP) and reference signal received quality (RSRQ) for a downlink, and report such measurements to the network device. In the case of a serving cell, the UE may determine channel state information (CSI), such as a channel quality indicator, a rank indicator, and a precoding matrix indicator based on measuring CSI reference signals transmitted by a network device. Other exemplary measurements for RRM may include interference measurements from neighboring cells, event-trigger measurements, mobility and handover-related measurements, determination of cell identify and cell identity groups for neighboring network devices, beam management measurements, UE positioning measurement, and network synchronization measurements.

At least in part to improve computational efficiency of RRM, a UE may use or rely on machine learning with reference to various management and control tasks, such as generating channel state information, transmission beam management, and geographic positioning determination. In one or more implementations, a UE can use machine learning to determine parameters for one or more transmission beams of a first set of transmission beams based on a second set of transmission beam measurements. Machine learning may include artificial intelligence in some cases. Processors, systems, servers, or other devices or components, or groups of any of these, which implement or perform machine learning may be referred to as a machine learning engine.

A machine learning engine may include and/or generate a machine learning model to find patterns or make decisions from a previously unseen dataset. In some examples, a machine learning model may refer to a program (algorithm, code, process). Additionally, or alternatively, a machine learning model may refer to parameters, values, data, or other inputs provided to a machine learning engine (e.g., a program) that define or otherwise control the operation of the machine learning engine. The machine learning model may be trained using a dataset, where the program is optimized to find certain patterns or outputs from the dataset. The output of the training is the machine learning model.

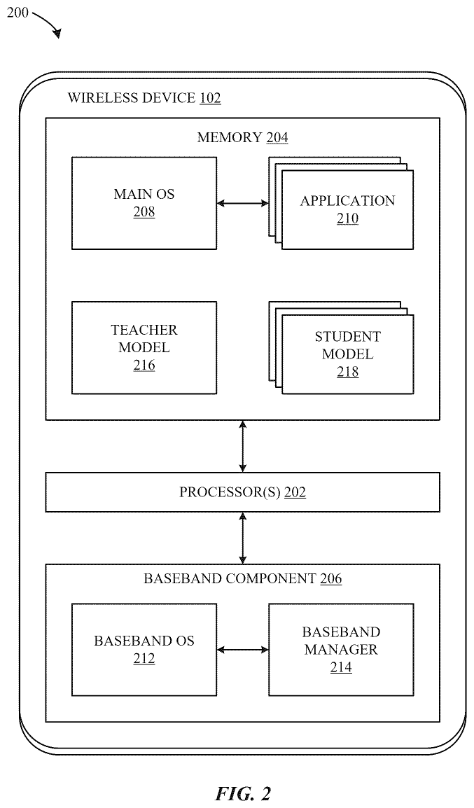

FIG. 2 illustrates a block diagram of a more detailed view 200 of exemplary components of the wireless device 102 of FIG. 1. As shown in FIG. 2, the wireless device 102 can include processing circuitry, which can include one or more processors 202 and a memory 204. The wireless device 102 can also include a baseband component 206 used for transmission and reception of cellular wireless radio frequency signals. The processor(s) 202 can include one or more wireless processors, such as a cellular baseband component, a wireless local area network processor, a wireless personal area network processor, a near-field communication processor, one or more system-level application processors, etc. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., processors 202, memory 204, and baseband component 206) can be used separately, arranged, or combined in any number of configurations.

The processor(s) 202, in conjunction with the memory 204, can implement a main operating system (OS) 208 that is configured to execute applications 210 (e.g., native OS applications and user applications). The one or more processors 202 can include applications processing circuitry and/or baseband processing circuitry and, in some implementations, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 206, and other sensors (not shown) to determine states of components of the wireless device 102, e.g., reduced power modes, as well as of the wireless device 102 as a whole, e.g., mobility states, activity/inactivity states.

The baseband component 206 of the wireless device 102 can include a baseband OS 212 that is configured to manage hardware resources of the baseband component 206 (e.g., a processor, a memory, different radio components, etc.). The baseband component 206 (or a portion thereof) can also be referred to as a baseband component, a wireless baseband component, a baseband wireless processor, a cellular baseband component, a cellular component, and the like. According to some implementations, the baseband component 206 can implement a baseband manager 214 that is configured to manage different connections between the wireless device 102 and MNOs 106.

The memory 204 can include a teacher model 216, which can also be referred to as a pre-trained complex model, a large complex model, or a source domain model. The teacher model 216 can be pre-trained offline using a comprehensive dataset that captures a range of propagation and channel conditions including, for example, multi-path fading, Doppler effects, varying signal-to-noise ratios, etc. The teacher model 216 can be configured to achieve high accuracy by learning robust representations of a wireless communication channel state (e.g., CSI, RSRP, RSRQ, beam conditions, etc.). Locally storing multiple complex models tailored to specific sets of channel conditions can by computationally expensive for the wireless device 102. Additionally, online generation and training of a complex model to match current channel conditions can be slow and computationally taxing for the wireless device 102.

Memory 204 can include one or more of student models 218, which can also be referred to as reduced-complexity models, small models, target domain models, etc. The student models 218 can be generated and trained online (e.g., in real-time or near real-time) due at least in part to their comparatively low computational complexity. Furthermore, a large quantity of the student models 218 can be stored in memory 204 due to their comparatively small memory footprint. Thus, one or more components within the wireless device 102 (e.g., processor(s) 202, memory 204, baseband component 206, etc.) can develop and store an ensemble of reduced-complexity models that are each tailored to a particular target domain. In this manner, fast access to a set of unique reduced-complexity models sufficient for the generalization of all (or most) target domains can be achieved. As described herein, the student models 218 are generated and trained by transferring applicable portions of knowledge from the teacher model 216 to the student models 218. One such approach to transfer knowledge can be referred to as knowledge distillation. Knowledge distillation can provide a form of model compression that allows a relatively simple model to perform tasks almost as accurately as a very complex model.

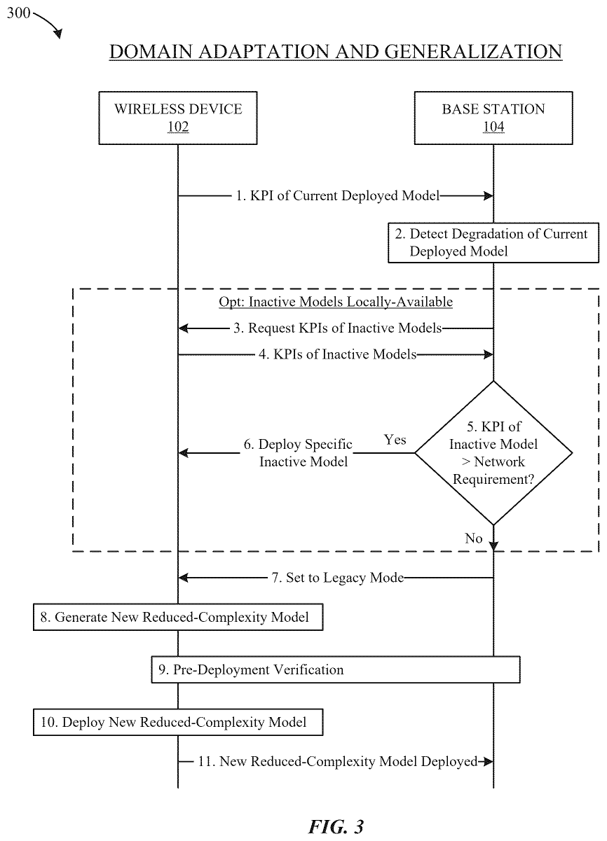

FIG. 3 illustrates a diagram of an example of a domain adaptation and generalization flow 300 for online generation of multiple reduced-complexity models. For simplicity of explanation, the domain adaptation and generalization flow 300 is depicted in FIG. 3 and described as a series of operations performed by the wireless device 102 and the base station 104. However, the operations can be performed by one or more components of the wireless device 102 (e.g., processor(s) 202, memory 204, baseband component 206, etc.) and/or by one or more components of the base station 104. At the start of the domain adaptation and generalization flow 300, a model is deployed by the wireless device 102. In some implementations, a current deployed model is the teacher model 216. Alternatively, or in addition, the current deployed model can be one of the student models 218. The wireless device 102 can send a key performance indicator (KPI) of the current deployed model to the base station 104. KPIs can include indicators for channel state feedback and processing such as feedback delay, channel state accuracy, and channel state update frequency. Alternatively, or in addition, KPIs can include indicators specific to a particular radio access technology, e.g., 5G, 6G, etc., such as channel state reference signal received power and a precoding matrix indicator. Alternatively, or in addition, KPIs can include indicators for system performance such as data throughput, latency, resource utilization, coverage area, and call completion rate. Alternatively, or in addition, KPIs can include indicators for channel quality and reliability such as a channel quality indicator, a signal-to-interference-plus-noise ratio, a packet loss rate, a bit error rate, and a channel capacity. The base station 104 can detect degradation of a current deployed model based on one or more of the KPI. Degradation of the current deployed model can occur due to changes in channel conditions or other factors. In some implementations, the base station 104 determines that the current deployed model is degraded and needs to be replaced when the KPI does not meet a network requirement. For example, the base station 104 may determine that the current deployed model needs to be replaced when the KPI indicates that the bit error rate is greater than a threshold rate.

When one or more inactive models are locally-available on the wireless device 102, the base station 104 can determine whether one or more of the inactive models are able to provide accurate predictions for current channel conditions. The inactive models can include student models 218 that are each tailored to a specific target domain. In some implementations, the base station 104 requests the KPIs of inactive models that are locally-available on the wireless device 102 (e.g., stored in memory 204). Responsive to the request, the wireless device 102 can send the KPIs of the inactive models to the base station 104. The base station 104 can determine whether the KPI of one of more of the inactive models meets network requirements. When the KPI of one of the inactive models meets network requirements, the base station 104 can request that the wireless device 102 deploy an associated specific inactive model. Alternatively, when the KPIs of all of the inactive models do not meet network requirements, the base station 104 can set the wireless device 102 to operate in a legacy mode. For example, the base station 104 can send a message to configure the wireless device 102 to operate in a legacy mode. Legacy mode is a mode of operation in which artificial intelligence and machine learning are not utilized. Setting the wireless device 102 to operate in the legacy mode can ensure that wireless communication between the wireless device 102 and the base station 104 remains stable during generation of a new reduced-complexity model.

The wireless device 102 can generate a new reduced-complexity model. In some implementations, the wireless device 102 generates the new reduced-complexity model through knowledge distillation as described in more detail herein. Pre-deployment verification may be performed on the new reduced-complexity model to validate performance before full deployment. In some implementations, a KPI of the new reduced-complexity model may be checked to ensure compliance with a network requirement. For example, the wireless device 102 can determine a KPI associated with the new reduced-complexity model. The wireless device 102 can send the KPI to the base station 104 and the base station 104 can determine whether the KPI meets the network requirement. When the KPI meets the network requirement, the base station 104 can send a verification to the wireless device 102. After verification, the wireless device 102 can deploy the new reduced-complexity model and inform the base station 104 that the new student model has been deployed. In some implementations, all (or a portion) of the domain adaptation and generalization flow 300 can be repeated after the new reduced-complexity model is deployed. For example, the new reduced-complexity model can remain deployed on the wireless device 102 until channel conditions change warranting generation of a newer reduced-complexity model to provide accurate predictions. After numerous iterations of the domain adaptation and generalization flow 300, the wireless device 102 can have fast access to a set of unique reduced-complexity models sufficient for the generalization of all (or most) target domains.

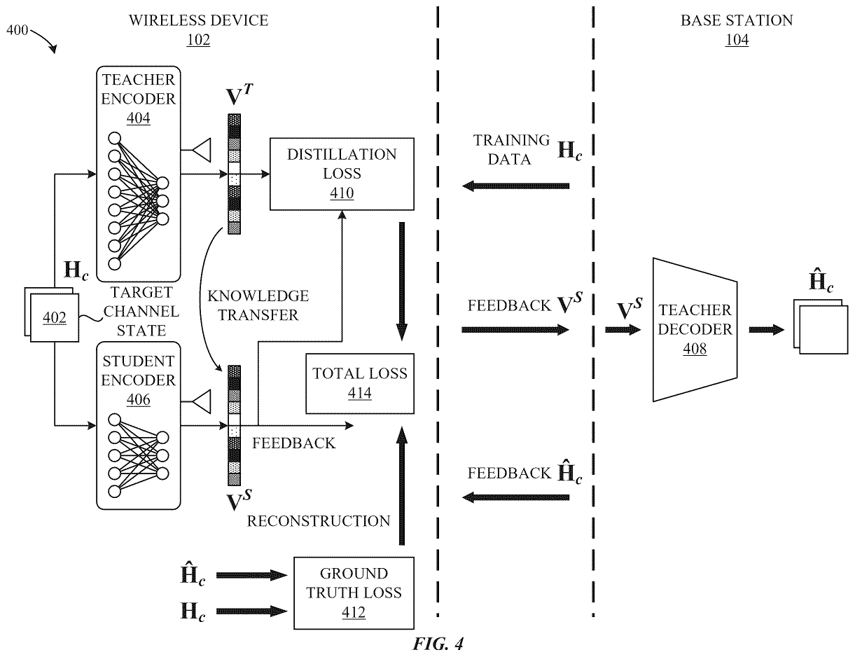

FIG. 4 illustrates a diagram of an example of a channel state feedback system 400. As illustrated in FIG. 4, training data H_{C} can sent from the base station 104 to the wireless device 102. For example, the base station 104 can send a set of reference signals as the training data H_{C}. The training data H_{C} can be used as a ground truth (e.g., the target channel state 402 in FIG. 4) to generate a new student model tailored to current channel conditions. A teacher encoder 404 (e.g., included in the teacher model 216) can generate teacher feedback V^{T} from the target channel state 402. The teacher feedback V^{T} is a compressed representation of the target channel state 402. The new student model generated by the channel state feedback system 400 includes a student encoder 406 that can generate student feedback V^{S} from the target channel state 402. The student feedback V^{S} is a compressed representation of the target channel state 402. The student feedback V^{S} can be sent from the wireless device 102 to the base station 104. A teacher decoder 408 (e.g., associated with the teacher model 216) can generate reconstructed feedback Ĥ_{C} from the student feedback V^{S}. The reconstructed feedback Ĥ_{C} is a reconstruction of the target channel state 402. The reconstructed feedback Ĥ_{C} can be sent from the base station 104 to the wireless device 102. Differences between the teacher feedback V^{T} and the student feedback V^{S} can define a distillation loss 410. Further, differences between the training data H_{C} and the reconstructed feedback Ĥ_{C} can define a ground truth loss 412. A combination of the distillation loss 410 and the ground truth loss 412 can define a total loss 414. The student encoder 406 can be trained to reduce the total loss 414. For example, one or more components of the wireless device 102 (e.g., processor(s) 202, memory 204, baseband component 206, etc.) can train the student encoder 406 to reduce the total loss 414 by transferring the knowledge of the teacher encoder 404 to the student encoder 406 through knowledge distillation.

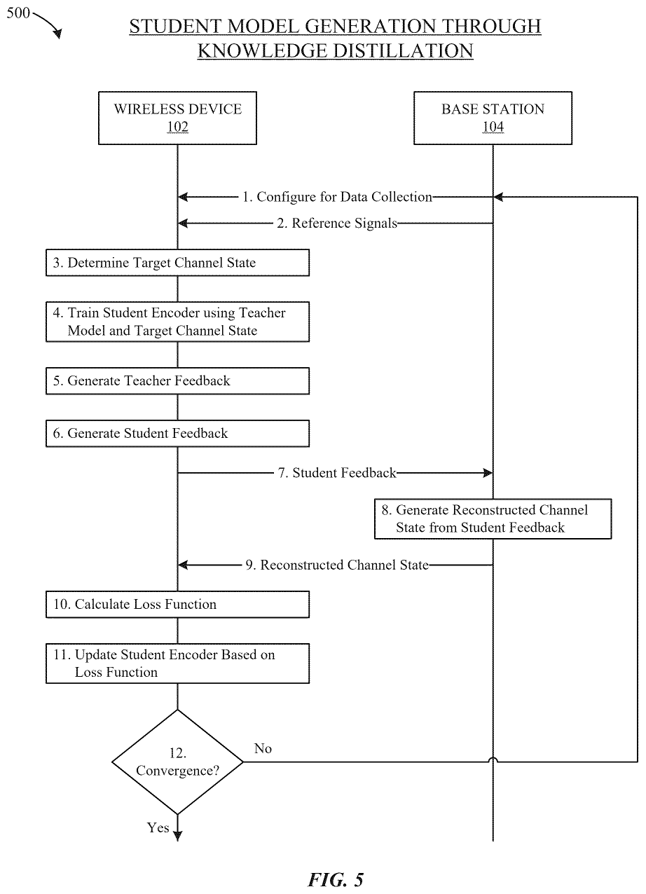

FIG. 5 illustrates a diagram of an example of a student model generation flow 500 to train an encoder for channel state feedback through knowledge distillation. For simplicity of explanation, the student model generation flow 500 is depicted in FIG. 5 and described as a series of operations performed by the wireless device 102 and the base station 104. However, the operations can be performed by one or more components of the wireless device 102 (e.g., processor(s) 202, memory 204, baseband component 206, etc.) or by one or more components of the base station 104. The base station 104 can configure the wireless device 102 for data collection. For example, the base station 104 can configure the wireless device 102 to obtain a set of reference signals received from the base station 104. In some implementations, the set of reference signals includes one or more reference signals used for channel state measurement, such as one or more CSI reference signals. The wireless device 102 can determine a target channel state 402 based on processing the set of obtained reference signals. For example, the wireless device 102 can use channel state measurements as the ground truth to generate a new student model tailored to the current channel conditions. The wireless device 102 can train the student encoder 406 using the teacher model 216 and the target channel state (as the ground truth). Next, the wireless device 102 can generate teacher feedback V^{T} with the teacher encoder 404. For example, the wireless device 102 can generate teacher codewords by encoding the target channel state using the teacher encoder 404. The teacher codewords are compressed representations of the target channel state 402. Next, the wireless device 102 can generate student feedback V^{S} using the student encoder 406. For example, the wireless device 102 can generate student codewords (or feedback codewords) by encoding the target channel state 402 with the student encoder 406. Similar to the teacher codewords, the student codewords are compressed representations of the target channel state 402. After generating the student feedback, the wireless device 102 can send the student feedback V^{S} to the base station 104. The base station 104 can generate a reconstructed version of the target channel state 402 from the student feedback (e.g., reconstructed feedback Ĥ_{C}). For example, the base station 104 can reconstruct the channel state by decoding the student codewords using the teacher decoder 408. The base station 104 can send the reconstructed channel state to the wireless device 102. The wireless device 102 can calculate a loss function for the new student model. For example, the loss function may be calculated using Equation 1 shown below:

$${L}_{K D} = a \times f ( {V}^{T} , {V}^{s} ) + ( 1 - a ) \times g ( {H}_{C} , {\hat{H}}_{C} ) \qquad Equation 1$$

wherein:
   L_{KD}=loss function,
a=weighting factor,
V^{T}=teacher feedback,
V^{S}=student feedback,
H_{C}=training data, and
Ĥ_{C}=reconstructed feedback.

The wireless device 102 can update the student encoder 406 based on the loss function. For example, the wireless device 102 can update one or more weights associated with the student encoder 406 in order to decrease the loss. Next, the wireless device 102 can determine whether the student encoder 406 has reached convergence. In some implementations, the wireless device 102 determines that the student encoder 406 has reached convergence when the loss function indicates a minor decrease in loss. For example, the wireless device 102 can determine that the student encoder 406 has reached convergence when the loss function indicates that further training of the student encoder 406 will not provide a significant increase in accuracy of the student encoder 406. When the wireless device 102 determines that the student encoder 406 has not reached convergence, all (or a portion) of the student model generation flow 500 can be repeated. Alternatively, when the wireless device 102 determines that the student encoder 406 has reached convergence, the student model generation flow 500 may end.

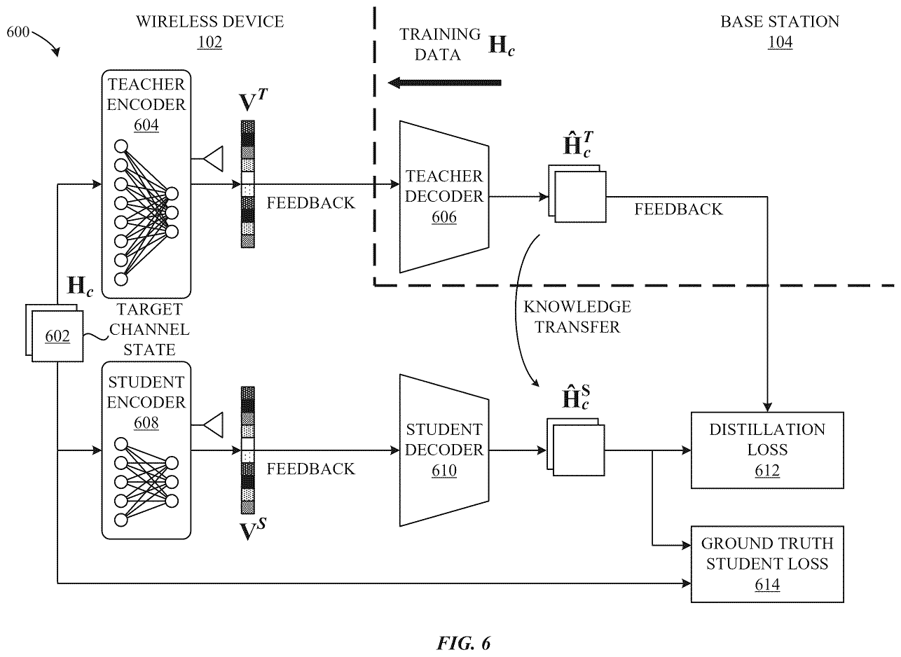

FIG. 6 illustrates a diagram of an example of a channel state feedback system 600. As illustrated in FIG. 6, training data H_{C} can sent from the base station 104 to the wireless device 102. For example, the base station 104 can send a set of reference signals as the training data H_{C}. The training data H_{C} can be used as a ground truth (e.g., the target channel state 602 in FIG. 6) to generate a new student model tailored to current channel conditions. A teacher encoder 604 (e.g., included in the teacher model 216) can generate teacher feedback V^{T} from the target channel state 602. The teacher feedback V^{T} is a compressed representation of the target channel state 602. The teacher feedback V^{T} can be sent from the wireless device 102 to the base station 104. A teacher decoder 606 (e.g., associated with the teacher model 216) can generate reconstructed feedback

$${\hat{H}}_{{}^{{}_{c}}}^{{}_{T}}$$

from the teacher feedback V^{T}. The reconstructed feedback

$${\hat{H}}_{{}^{{}_{c}}}^{{}_{T}}$$

is a reconstruction of the target channel state 602. The reconstructed feedback

$${\hat{H}}_{{}^{{}_{c}}}^{{}_{T}}$$

can be sent from the base station 104 to the wireless device 102. The new student model generated by the channel state feedback system 600 includes a student encoder 608 that can generate student feedback V^{S} from the target channel state 602. The student feedback V^{S} is a compressed representation of the target channel state 402. The new student model generated by the channel state feedback system 600 also includes a student decoder 610 that can generate reconstructed feedback

$${\hat{H}}_{{}^{{}_{c}}}^{{}_{S}}$$

from the student feedback V^{S}. The reconstructed feedback

$${\hat{H}}_{{}^{{}_{c}}}^{{}_{S}}$$

is a reconstruction of the target channel state 602. Differences between the reconstructed feedback

$${\hat{H}}_{{}^{{}_{c}}}^{{}_{T}}$$

from the teacher decoder 606 and the reconstructed feedback

$${\hat{H}}_{{}^{{}_{c}}}^{{}_{S}}$$

from the student decoder 610 can define a distillation loss 612. Further, differences between the target channel state 602 and the reconstructed feedback

$${\hat{H}}_{{}^{{}_{c}}}^{{}_{S}}$$

from the student decoder 610 can define a ground truth student loss 614. The student decoder 610 can be trained to reduce the distillation loss 612, the ground truth student loss 614, or a combination thereof. For example, one or more components of the wireless device 102 (e.g., processor(s) 202, memory 204, baseband component 206, etc.) can train the student decoder 610 to reduce loss by transferring the knowledge of the teacher decoder 606 to the student decoder 610 through knowledge distillation.

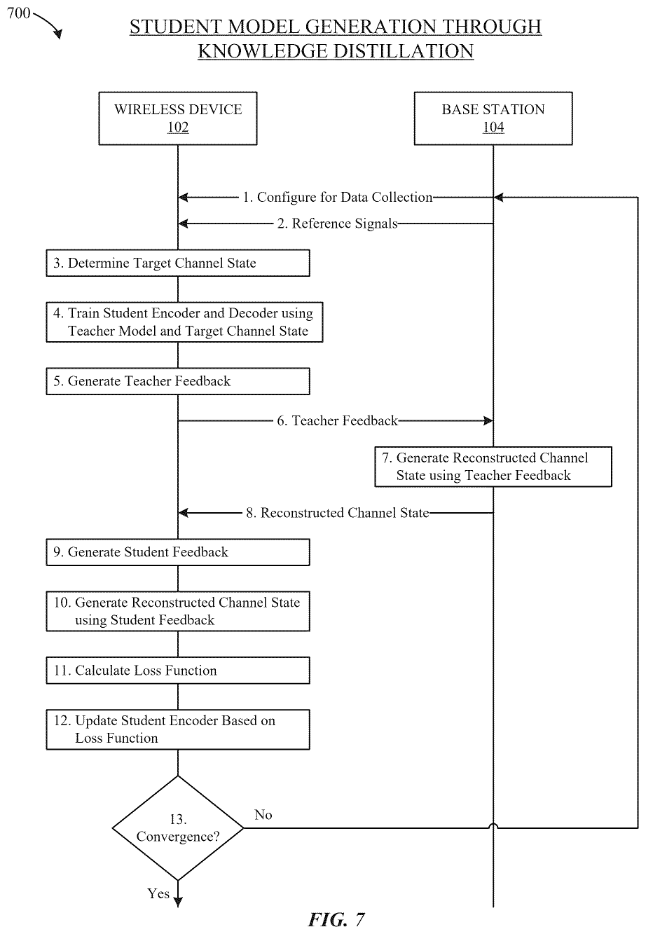

FIG. 7 illustrates a diagram of an example of a student model generation flow 700 to train an encoder and a decoder for channel state feedback through knowledge distillation. For simplicity of explanation, the student model generation flow 700 is depicted in FIG. 7 and described as a series of operations performed by the wireless device 102 and the base station 104. However, the operations can be performed by one or more components of the wireless device 102 (e.g., processor(s) 202, memory 204, baseband component 206, etc.) or by one or more components of the base station 104. The base station 104 can configure the wireless device 102 for data collection. For example, the base station 104 can configure the wireless device 102 to obtain a set of reference signals received from the base station 104. The wireless device 102 can determine a target channel state 602 based on the set of reference signals. The wireless device 102 can train the student encoder 608 and the student decoder 610 using the teacher model 216 and the target channel state (as the ground truth). Next, the wireless device 102 can generate teacher feedback V^{T} using the teacher encoder 604. For example, the wireless device 102 can generate teacher codewords by encoding the target channel state 602 with the teacher encoder 604. After generating the teacher feedback, the wireless device 102 can send the teacher feedback V^{T} to the base station 104. The base station 104 can generate a reconstructed version of the target channel state 602 from the teacher feedback V^{T} (e.g., reconstructed feedback

$${\hat{H}}_{{}^{{}_{C}}}^{{}_{T}} ) .$$

For example, the base station 104 can reconstruct the channel state by decoding the teacher codewords with the teacher decoder 606. Next, the wireless device 102 can generate student feedback V^{S} using the student encoder 608. For example, the wireless device 102 can generate student codewords (or feedback codewords) by encoding the target channel state 602 with the student encoder 608. After generating the student feedback V^{S}, the wireless device 102 can generate a reconstructed version of the target channel state 602 from the student feedback V^{S} (e.g., reconstructed feedback

$${\hat{H}}_{{}^{{}_{C}}}^{{}_{S}} ) .$$

For example, the wireless device 102 can reconstruct the channel state by decoding the student codewords with the student decoder 608. The wireless device 102 can calculate a loss function for the new student model. For example, the loss function may be calculated using Equation 2 shown below:

$${L}_{KD} = a \times f ( {\hat{H}}_{C}^{T} , {\hat{H}}_{C}^{S} ) + ( 1 - a ) \times g ( {H}_{C} , {\hat{H}}_{C}^{S} ) \qquad Equation 2$$

wherein:
   L_{KD}=loss function,
   a=weighting factor,

$${\hat{H}}_{C}^{T}$$

=reconstructed channel state from teacher decoder 606,

$${\hat{H}}_{C}^{S}$$

=reconstructed channel state from student decoder 610, and
H_{C}=target channel state.

The wireless device 102 can update the student encoder based on the loss function. For example, the wireless device 102 can update one or more weights associated with the student encoder in order to decrease the loss. In some implementations, the wireless device 102 can also update the student decoder based on the loss function. Next, the wireless device 102 can determine whether the student encoder and the student decoder have reached convergence. In some implementations, the wireless device 102 determines that the student decoder and the student decoder have reached convergence when the loss function indicates a minor decrease in loss. When the wireless device 102 determines that the student decoder and the student encoder have not reached convergence, all (or a portion) of the student model generation flow 700 can be repeated. Alternatively, when the wireless device 102 determines that the student decoder and the student encoder have reached convergence, the student model generation flow 700 may end.

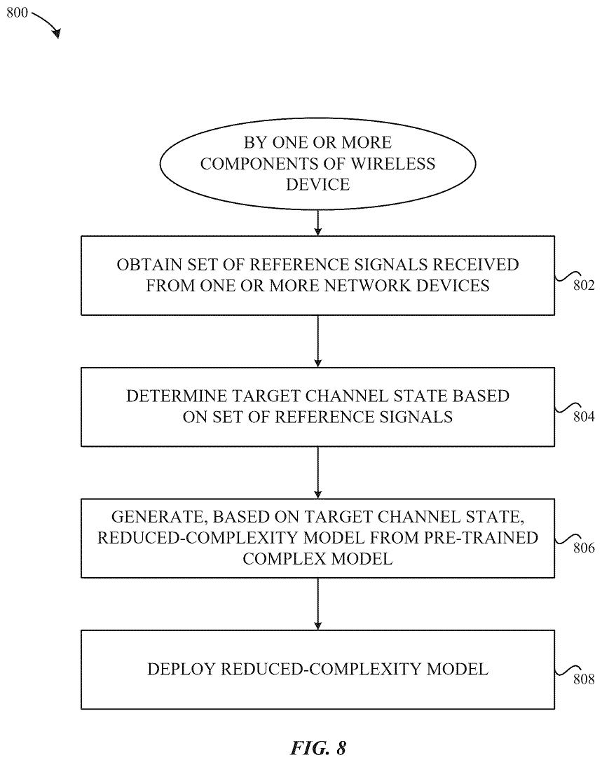

FIG. 8 is a flow diagram of an example of a method 800 for domain adaptation and generalization for channel state feedback. For simplicity of explanation, the method 800 is depicted in FIG. 8 and described as a series of operations. However, the operations can occur in various orders and/or concurrently, and/or with other operations not presented and described herein. At block 802, a set of reference signals is received from one or more network devices is obtained. For example, one or more components of the wireless device 102 (e.g., processors(s) 202, memory 204, baseband component 206, etc.) can obtain CSI reference signals received from one or more of the group of base stations 104-1 to 104-N. At block 804, a target channel state is determined based on the set of reference signals. For example, one or more components of the wireless device 102 can use measurements of the set of reference signals as the ground truth to generate a new student model tailored to the current channel conditions. At block 806, a reduced-complexity model is generated from a pre-trained complex model based on the target channel state. For example, one or more components of the wireless device 102 can generate a new student model as described above in reference to FIGS. 4, 5, 6, and 7. At block 808, the reduced-complexity model is deployed. For example, one or more components of the wireless device 102 may use the reduced-complexity model to provide channel state feedback and/or beam reports to a network device.

### Representative Exemplary Apparatus

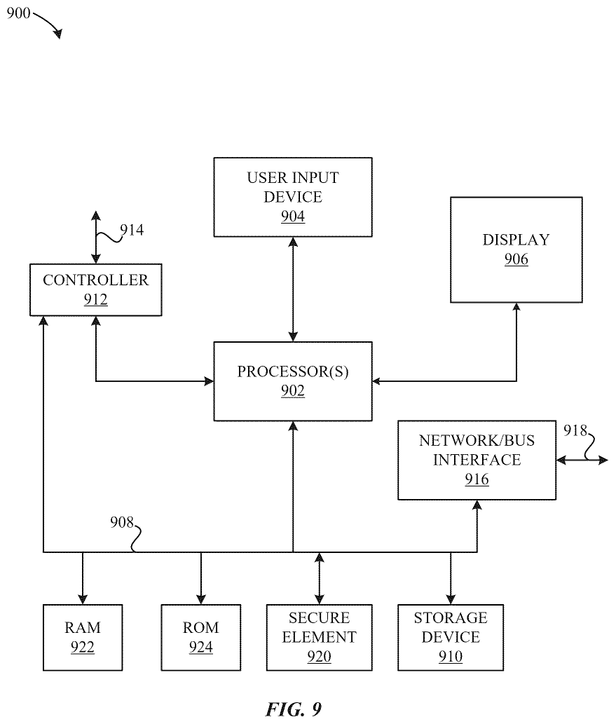

FIG. 9 is a block diagram of an example of a computing device 900 that can be used to implement the various components and techniques described herein, according to some implementations. In particular, the detailed view of the computing device 900 illustrates various components that can be included in the wireless device 102. As shown in FIG. 9, the computing device 900 can include one or more processors 902 that represent microprocessors or controllers for controlling the overall operation of the computing device 900. In some implementations, the computing device 900 can also include a user input device 904 that allows a user of the computing device 900 to interact with the computing device 900. For example, in some implementations, the user input device 904 can take a variety of forms, such as a button, keypad, dial, touch screen, audio input interface, visual/image capture input interface, input in the form of sensor data, etc. In some implementations, the computing device 900 can include a display 906 (screen display) that can be controlled by the processor(s) 902 to display information to the user (for example, information relating to incoming, outgoing, or active communication sessions). A data bus 908 can facilitate data transfer between at least the processor(s) 902, a storage device 910, and a controller 912. The controller 912 can be used to interface with and control different equipment through an equipment control bus 914. The computing device 900 can also include a network/bus interface 916 that couples to a data link 918. In the case of a wireless connection, the network/bus interface 916 can include wireless circuitry, such as a wireless transceiver and/or baseband component. The computing device 900 can also include a secure element 920.

The storage device 910 can include a single disk or a plurality of disks (e.g., hard drives and/or solid-state drives), and includes a storage management module that manages one or more partitions within the storage device 910. In some implementations, the storage device 910 can include flash memory, semiconductor (solid state) memory or the like. The computing device 900 can also include a Random Access Memory (RAM) 922 and a Read-Only Memory (ROM) 924. The RAM 922 can provide volatile data storage, and stores instructions related to the operation of the computing device 900. The ROM 924 can store programs, utilities or processes to be executed in a non-volatile manner.

### Wireless Terminology

In accordance with various implementations described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various implementations of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN), a wireless local area network (WLAN), a wireless personal area network (WPAN), a near field communication (NFC), a cellular wireless network, a fourth generation (4G) Long Term Evolution (LTE), LTE Advanced (LTE-A), 5G, and/or 6G, or other present or future developed advanced cellular wireless networks.

The wireless communication device, in some implementations, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some implementations, the client device can be any wireless communication device that is capable of communicating via a WLAN technology, e.g., in accordance with a wireless local area network communication protocol. In some implementations, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless devices that are also capable of communicating via different radio access technologies (RATs). In these scenarios, a multi-mode UE can be configured to prefer attachment to a 5G wireless network offering faster data rate throughput, as compared to other 4G LTE legacy networks offering lower data rate throughputs. For instance, in some implementations, a multi-mode UE may be configured to fall back to a 4G LTE or a 3G legacy network, e.g., an Evolved High-Speed Packet Access (HSPA+) network or a Code Division Multiple Access (CDMA) 2000 Evolution-Data Only (EV-DO) network, when 5G wireless networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for domain adaptation and generalization for channel state feedback, the method comprising:
by one or more components of a wireless device:
obtaining a set of reference signals received from one or more network devices;
determining a target channel state based on the set of reference signals;
generating, based on the target channel state, a reduced-complexity model from a pre-trained complex model; and
deploying the reduced-complexity model.

2. The method of claim 1, wherein generating the reduced-complexity model further includes:
generating a first compressed channel state representation by encoding the target channel state using the pre-trained complex model;
generating a second compressed channel state representation by encoding the target channel state using the reduced-complexity model;
sending the second compressed channel state representation to one of the one or more network devices;
receiving a reconstructed channel state from the one of the one or more network devices;
calculating a loss function based on the first compressed channel state representation, the second compressed channel state representation, the target channel state, and the reconstructed channel state; and
updating the reduced-complexity model based on the loss function.

3. The method of claim 1, wherein generating the reduced-complexity model further includes:
generating a first compressed channel state representation by encoding the target channel state using the pre-trained complex model;
sending the first compressed channel state representation to one of the one or more network devices;
receiving a first reconstructed channel state from the one of the one or more network devices;
generating a second compressed channel state representation by encoding the target channel state using the reduced-complexity model;
generating a second reconstructed channel state by decoding the second compressed channel state representation using the reduced-complexity model;
calculating a loss function based on the first reconstructed channel state, the second reconstructed channel state, and the target channel state; and
updating the reduced-complexity model based on the loss function.

4. The method of claim 1, wherein deploying the reduced-complexity model further comprises:
determining a key performance indicator (KPI) associated with the reduced-complexity model;
sending the KPI to one of the one or more network devices; and
receiving, from the one of the one or more network devices, a verification indicating that the KPI meets a network requirement.

5. The method of claim 1, wherein the reduced-complexity model is a first reduced-complexity model, wherein the method further comprising:
after deploying the first reduced-complexity model on the wireless device
determining a first key performance indicator (KPI) associated with first reduced-complexity model, wherein the first KPI does not meet a first network requirement;
determining a second KPI associated with a second reduced-complexity model available in the wireless device, wherein the second KPI meets a second network requirement;
sending the first KPI and the second KPI to one of the one or more network devices;
receiving, from the one of the one or more network devices, a request to deploy the second reduced-complexity model; and
deploying the second reduced-complexity model on the wireless device.

6. The method of claim 1, wherein the reduced-complexity model is a first reduced-complexity model, wherein the set of reference signals is a first set of reference signals, wherein the target channel state is a first target channel state, and wherein the method further comprising:
after deploying the first reduced-complexity model on the wireless device
determining a key performance indicator (KPI) associated with first reduced-complexity model, wherein the KPI does not meet a network requirement;
sending the KPI to one of the one or more network devices;
receiving a second set of reference signals from the one or more network devices;
determining a second target channel state based on the second set of reference signals;
generating, based on the second target channel state, a second reduced-complexity model from the pre-trained complex model; and
deploying the second reduced-complexity model on the wireless device.

7. The method of claim 6, further comprising:
setting the wireless device to a legacy mode of operation after sending the KPI to the one of the one or more network devices and before receiving the second set of reference signals.

8. An apparatus comprising memory coupled to processing circuitry, the processing circuitry configured to:
receive a set of reference signals from one or more network devices;
determine a target channel state based on the set of reference signals;
generate, based on the target channel state, a student model from a teacher model; and
deploy the student model on the apparatus.

9. The apparatus of claim 8, wherein the teacher model includes a teacher encoder, wherein the student model includes a student encoder, and wherein, to generate the student model, the processing circuitry is further configured to:
generate first codewords from the target channel state using the teacher encoder;
generate second codewords from the target channel state using the student encoder;
send the second codewords to one of the one or more network devices;
receive a reconstructed channel state from the one of the one or more network devices;
calculate a loss function based on the first codewords, the second codewords, the target channel state, and the reconstructed channel state; and
update the student model based on the loss function.

10. The apparatus of claim 8, wherein the teacher model includes a teacher encoder, wherein the student model includes a student encoder and a student decoder, and wherein, to generate the student model, the processing circuitry is further configured to:
generate first codewords from the target channel state using the teacher encoder;
send the first codewords to one of the one or more network devices;
receive a first reconstructed channel state from the one of the one or more network devices;
generate second codewords from the target channel state using the student encoder;
generate a second reconstructed channel state from the second codewords using the student decoder;
calculate a loss function based on the first reconstructed channel state, the second reconstructed channel state, and the target channel state; and
update the student model based on the loss function.

11. The apparatus of claim 8, wherein, to deploy the student model, the processing circuitry is further configured to:
determine a key performance indicator (KPI) associated with the student model,
send the KPI to one of the one or more network devices, and
receive a verification from the one of the one or more network devices, wherein the verification indicating that the KPI meets a network requirement.

12. The apparatus of claim 8, wherein the student model is a first student model, wherein the processing circuitry is further configured to:
after the first student model is deployed on the apparatus
determine a first key performance indicator (KPI) associated with first student model, wherein the first KPI does not meet a first network requirement;
determine a second KPI associated with a second student model available in the memory, wherein the second KPI meets a second network requirement;
send the first KPI and the second KPI to one of the one or more network devices;
receive, from the one of the one or more network devices, a request to deploy the second student model; and
deploy the second student model on the apparatus.

13. The apparatus of claim 12, wherein the first student model is associated with a first target domain, and wherein the second student model is associated with a second target domain.

14. The apparatus of claim 8, wherein the student model is a first student model, wherein the set of reference signals is a first set of reference signals, wherein the target channel state is a first target channel state, and wherein the processing circuitry is further configured to:
after the first student model is deployed on the apparatus
determine a key performance indicator (KPI) associated with first student model, wherein the KPI does not meet a network requirement;
send the KPI to one of the one or more network devices;
receive a second set of reference signals from the one or more network devices;
determine a second target channel state based on the second set of reference signals;
generate, based on the second target channel state, a second student model from the teacher model; and
deploy the second student model on the apparatus.

15. The apparatus of claim 14, wherein the processing circuitry is further configured to set the apparatus to a legacy mode of operation after sending the KPI to the one of the one or more network devices and before receiving the second set of reference signals.

16. The apparatus of claim 8, wherein a complexity level of the teacher model is greater than a complexity constraint of the apparatus, and wherein a complexity level of the student model is less than or equal to the complexity constraint of the apparatus.

17. The apparatus of claim 8, wherein the set of reference signals includes a set of channel state information reference signals.

18. A non-transitory computer-readable storage medium storing instructions to configure one or more components of a wireless device to:
receive a set of reference signals from one or more network devices;
determine a ground truth channel state based on the set of reference signals;
generate, based on the ground truth channel state, a reduced-complexity model from a pre-trained complex model; and
deploy the reduced-complexity model on the wireless device.

19. The non-transitory computer-readable storage medium of claim 18, wherein, to generate the reduced-complexity model, the instructions further configure the one or more components of the wireless device to:
generate a first compressed channel state representation by encoding the ground truth channel state using the pre-trained complex model;
generate a second compressed channel state representation by encoding the ground truth channel state using the reduced-complexity model;
send the second compressed channel state representation to one of the one or more network devices;
receive a reconstructed channel state from the one of the one or more network devices;
calculate a loss function based on the first compressed channel state representation, the second compressed channel state representation, the ground truth channel state, and the reconstructed channel state; and
update the reduced-complexity model based on the loss function.

20. The non-transitory computer-readable storage medium of claim 18, wherein, to generate the reduced-complexity model, the instructions further configure the one or more components of the wireless device to:
generate a first compressed channel state representation by encoding the ground truth channel state using the pre-trained complex model;
send the first compressed channel state representation to one of the one or more network devices;
receive a first reconstructed channel state from the one of the one or more network devices;
generate a second compressed channel state representation by encoding the ground truth channel state using the reduced-complexity model;
generate a second reconstructed channel state by decoding the second compressed channel state representation using the reduced-complexity model;
calculate a loss function based on the first reconstructed channel state, the second reconstructed channel state, and the ground truth channel state; and
update the reduced-complexity model based on the loss function.
